(19) United States
(12) Patent Application Publication
(10) Pub. No.: US 2015/0194897 A1
(43) Pub. Date: Jul. 9, 2015

(54) POWER SUPPLY APPARATUS

(71) Applicants: SAMSUNG ELECTRO-MECHANICS CO., LTD., Suwon (KR); KOREA ADVANCED INSTITUTE OF SCIENCE AND TECHNOLOGY, Daejeon (KR)

(72) Inventors: Chong Eun KIM, Suwon (KR); Jong Woo KIM, Seoul (KR); Duk You KIM, Seoul (KR); Gun Woo MOON, Daejeon (KR)

(73) Assignees: SAMSUNG ELECTRO-MECHANICS CO., LTD., Suwon (KR); KOREA ADVANCED INSTITUTE OF SCIENCE AND TECHNOLOGY, Daejeon (KR)

(21) Appl. No.: 14/308,951

(22) Filed: Jun. 19, 2014

(30) Foreign Application Priority Data
Jan. 3, 2014 (KR) 10-2014-0000866

(51) Int. Cl. H02M 3/335

(52) U.S. Cl. CPC H02M 3/33507

(57) ABSTRACT

A power supply apparatus may include a main power supply unit including a transformer switching and transforming input power and converting the input power into main power having a preset magnitude to provide the main power to a main output terminal, a power transferring unit providing the main power to a standby power supply unit, and a standby power supply unit including an auxiliary winding coupled to the transformer, providing operating power to a first controller by the auxiliary winding and receiving the main power to provide the main power to a second controller and a standby output terminal when the main power supply unit is operated.

### CROSS-REFERENCE TO RELATED APPLICATION

This application claims the benefit of Korean Patent Application No. 10-2014-0000866 filed on Jan. 3, 2014, with the Korean Intellectual Property Office, the disclosure of which is incorporated herein by reference.

### BACKGROUND

The present disclosure relates to a power supply apparatus having reduced power loss.

In recent, several kinds of electronic apparatuses, meeting various user requirements, such as computers, display devices, controllers and the like, have been used in domestic, commercial and industrial settings.

Electronic apparatuses essentially use a power supply apparatus providing driving power to the inside or the outside thereof to perform various operations meeting various user requirements.

Particularly, an electronic apparatus, such as a server, continuously using high capacity power requires such a power supply apparatus.

In general, an existing power supply apparatus may use a flyback converter having a simple structure to generate standby power. Such a flyback converter may have a low degree of efficiency due to high voltage stress and hard switching.

A power supply apparatus as described above has a structure in which a standby stage supplies operating power and standby power using direct current power from a power factor correction (PFC) unit, and a DC/DC stage receives the operating power from the standby stage and supplies a main voltage using the direct current power from the PFC unit.

However, as described in the following Related Art Document, the power supply apparatus according to the related art uses a flyback converter in the standby stage, and has approximately 98% efficiency in the PFC unit, 96% efficiency in the DC/DC stage, and 80% efficiency in the standby stage under a load of 50% in a state in which an input voltage of approximately 230 Vac is input.

Therefore, since the power supply apparatus according to the related art has very low efficiency in the standby stage, efficiency in the entirety of the electronic apparatus, particularly, in a server using the power supply apparatus, may be degraded.

### RELATED ART DOCUMENT

Korean Patent Laid-Open Publication No. 2008-0024321

### SUMMARY

Some embodiments of the present disclosure may provide a power supply apparatus having improved power efficiency.

According to some embodiments of the present disclosure, a power supply apparatus may include: a main power supply unit including a transformer switching and transforming input power and converting the input power into main power having a preset magnitude to provide the main power to a main output terminal; a power transferring unit providing the main power to a standby power supply unit; and a standby power supply unit including an auxiliary winding coupled to the transformer, providing operating power to a first controller by the auxiliary winding and receiving the main power to provide the main power to a second controller and a standby output terminal when the main power supply unit is operated.

The standby power supply unit may convert the input power into operating power having a preset magnitude to provide the operating power to the first controller and convert the input power into power having a preset magnitude to provide the power to the second controller and the standby output terminal, when the main power supply unit is not operated.

The power transferring unit may include a transfer diode having an anode connected to the main output terminal and a cathode connected to the standby output terminal, and the transfer diode may be turned on by the main power from the main power supply unit and provide standby power to the standby power supply unit.

The main power supply unit may include: a primary side circuit unit including a primary side winding of the transformer and a plurality of primary side switching devices controlling a current flowing in the primary side winding of the transformer; and a secondary side circuit unit including a plurality of secondary side windings magnetically coupled to the primary side winding of the transformer and a plurality of secondary side switching devices conducting currents from the secondary side windings.

The primary side switching devices may include a first switching device and a second switching device connected to each other in series and a third switching device and a fourth switching device connected to each other in series, both terminals of the first switching device and the second switching device connected in series may be connected to a power input terminal in parallel and both terminals of the third switching device and the fourth switching device connected in series may be connected to the power input terminal in parallel, and the primary side winding of the transformer may be connected between a first node, a connection point between the first switching device and the second switching device, and a second node, a connection point between the third switching device and the fourth switching device.

The secondary side winding may include a first secondary side winding and a second secondary side winding connected to each other in parallel, and the secondary side switching devices may include a fifth switching device allowing for or cutting a flow of current in the first secondary side winding and a sixth switching device allowing for or cutting a flow of current in the second secondary side winding.

The standby power supply unit may include a first flyback converter converting the input power into the operating power having the preset magnitude to provide the operating power to the first controller and a second flyback converter converting the input power into the power having the preset magnitude.

The first flyback converter and the second flyback converter may be operated in a bust mode when the main power supply unit is operated.

The first flyback converter and the second flyback converter may be stopped when the main power supply unit is operated.

According to some embodiments of the present disclosure, a power supply apparatus may include: a main power supply unit including a transformer switching and transforming input power and converting the input power into main power having a preset magnitude to provide the main power to a main output terminal; a power transferring unit providing the main power to a standby power supply unit; and a standby power supply unit including a first controller receiving operating power by an auxiliary winding coupled to the transformer and a second controller receiving power by the power transferring unit, when the main power supply unit is operated.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a diagram illustrating a power supply apparatus according to an exemplary embodiment of the present disclosure;

FIGS. 2A and 2B are diagrams illustrating examples of a switching control waveform of a phase shift full-bridge converter;

FIG. 3 is a diagram illustrating a power supply path to a first controller, a second controller, and a standby output terminal when a main power supply unit is not operated;

FIG. 4 is a diagram illustrating the power supply path to the first controller, the second controller, and the standby output terminal when the main power supply unit is operated;

FIG. 5 is a waveform diagram illustrating an operation and standby power of a flyback converter of a standby power supply unit according to an operation of the main power supply unit;

FIG. 6 is a diagram illustrating a waveform of a voltage applied to the first controller; and

FIG. 7 is a diagram illustrating power supply efficiencies according to load conditions of a power supply apparatus for a server according to an exemplary embodiment of the present disclosure and a power supply apparatus for a server according to the related art.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

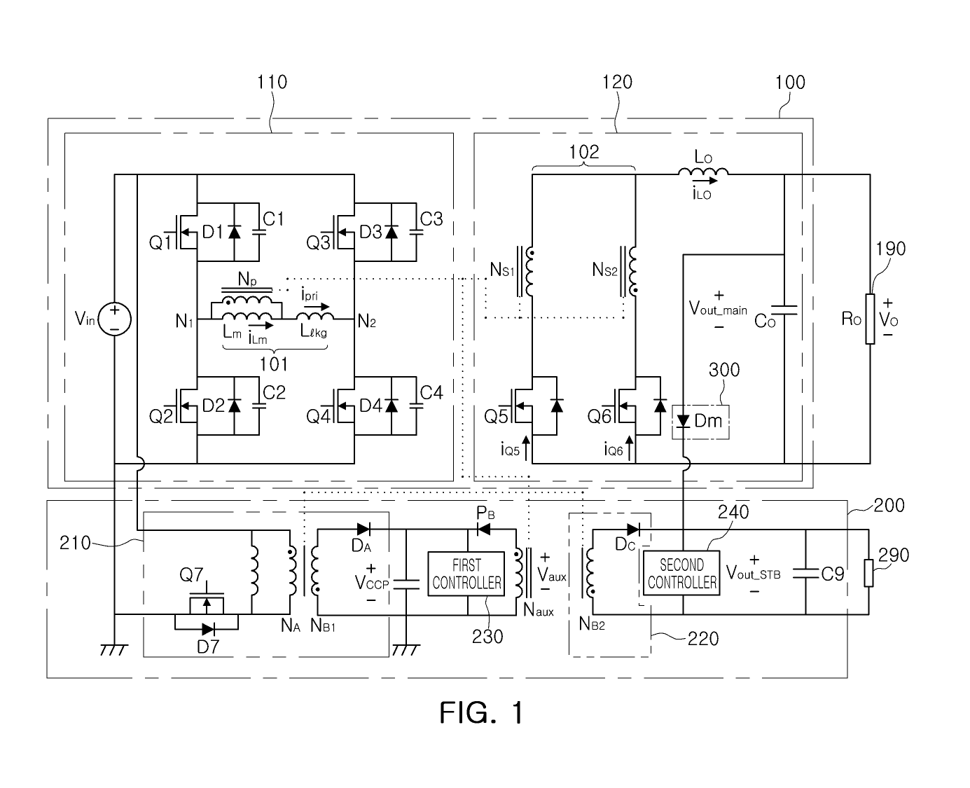

FIG. 1 is a diagram illustrating a power supply apparatus according to an exemplary embodiment of the present disclosure.

Referring to FIG. 1, the power supply apparatus may include a main power supply unit 100, a power transferring unit 300, and a standby power supply unit 200.

Here, input power applied to the main power supply unit 100 and the standby power supply unit 200 may be power provided by a power factor correcting unit. For example, the power factor correcting unit may convert alternating current power into direct current power having a preset magnitude and provide the direct current power to the main power supply unit 100 and the standby power supply unit 200.

The main power supply unit 100 may include a transformer switching and transforming the input power, and convert the input power into main power Vout_main having a preset magnitude to provide the main power to a main output terminal 190.

Meanwhile, the main power supply unit 100 according to an exemplary embodiment of the present disclosure may include a primary side circuit unit 110 and a secondary side circuit unit 120. Meanwhile, the main power supply unit 100 may be implemented in a form of a phase shift full-bridge DC/DC converter as shown in FIG. 1.

Since the phase shift full-bridge DC/DC converter has relatively high efficiency due to low current/voltage stress and zero voltage switching (ZVS), the phase shift full-bridge DC/DC converter may be significantly useful in terms of power applications.

In further detail, the phase shift full-bridge converter according to an exemplary embodiment of the present disclosure may include a bridge circuit Q₁ to Q₄ in which both terminals of a first switching device Q₁ and a second switching device Q₂ connected in series are connected to a power input terminal Vin in parallel and both terminals of a third switching device Q₃ and a fourth switching device Q₄ connected in series are connected to the power input terminal Vin in parallel, a transformer 101 and 102 having a primary side winding 101 connected between a first node N₁, a connection point between the first switching device Q₁ and the second switching device Q₂, and a second node N₂, a connection point between the third switching device Q₃ and the fourth switching device Q₄ and at least one or more secondary side windings 102 magnetically coupled to the primary side winding 101, an inductor device L_{O} connected to the secondary side windings 102 of the transformer 101 and 102, and a capacitor device C_{O}.

In addition, the power supply apparatus may include fifth and sixth switching devices Q₅ and Q₆ for allowing for or cutting the flow of currents i_{Q5} and i_{Q6} in the secondary side winding 102 of the transformer 102.

The secondary side winding 102 may include a first secondary side winding Nₛ₁ and a second secondary side winding Nₛ₂ connected to each other in parallel. The fifth switching device Q₅ may allow for or cutting the flow of current in the first secondary side winding Nₛ₁. The sixth switching device Q₆ may allow for or cut the flow of current in the second secondary side winding Nₛ₂.

Meanwhile, a turn ratio of the transformer 101 and 102 may be Nₚ:Nₛ₁=n:1 and Nₚ:Nₛ₂=n:1, and the primary side winding 101 may be represented by components of leakage inductance L_{1kg} and magnetizing inductance Lm as shown in FIG. 1. Meanwhile, the first switching device Q₁ to the fourth switching device Q₄ may include diodes D₁ to D₄ and parasitic capacitance components C₁ to C₄, respectively.

Hereinafter, a configuration including at least one of the power input terminal Vin, the first switching device Q₁ to the fourth switching device Q₄, and the primary side winding 101 of the transformer 101 and 102 will be defined as a primary side circuit unit 110 of the phase shift full-bridge converter. In addition, a configuration including at least one of the secondary side winding 102 of the transformer 101 and 102, the fifth switching device Q₅, the sixth switching device Q₆, an inductor device LO, and the capacitor Cₒ will be defined as a secondary side circuit unit 120 of the phase shift full-bridge converter.

In addition, the first switching device Q₁ to the fourth switching device Q₄ included in the primary side circuit unit 110 will be defined as primary side switching devices. In addition, the fifth switching device Q₅ and the sixth switching device Q₆ included in the secondary side circuit unit 120 will be defined as secondary side switching devices.

First and second controllers 230 and 240 may control the secondary side switching devices based on a turn-on operation period of the primary side switching devices.

For example, the first and second controllers 230 and 240 may synchronize a period in which the primary side circuit unit 110 is powered and a period in which one of the secondary side switching devices is turned on. In detail, the first and second controllers 230 and 240 may turn on one of the secondary side switching devices when the primary side circuit unit 110 is powered.

Here, the period in which the primary side circuit unit 110 is powered indicates a period in which energy is transferred from the primary side circuit unit 110 to the secondary side circuit unit 120. For example, the period in which the primary side circuit unit 110 is powered may indicate a period in which the first switching device Q₁ and the fourth switching device Q₄ are concurrently turned on and a period in which the second switching device Q₂ and the third switching device Q₃ are concurrently turned on.

In addition, the first and second controllers 230 and 240 may synchronize a period in which the primary side circuit unit 110 is freewheeled and a period in which the plurality of secondary side switching devices are turned off. In detail, the first and second controllers 230 and 240 may turn off the plurality of secondary side switching devices when the primary side circuit unit 110 is freewheeled.

Here, the period in which the primary side circuit unit 110 is freewheeled indicates a period except for the period in which the primary side circuit unit 110 is powered. For example, the period in which the primary side circuit unit 110 is freewheeled may indicate a period in which the first switching device Q₁ and the fourth switching device Q₄ are not concurrently turned on and a period in which the second switching device Q₂ and the third switching device Q₃ are not concurrently turned on.

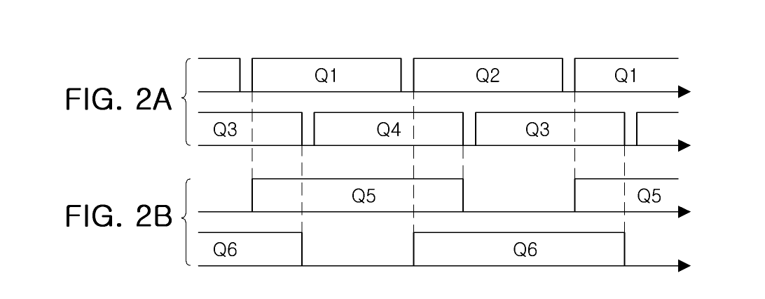

FIGS. 2A and 2B are diagrams illustrating examples of a switching control waveform of a phase shift full-bridge converter.

FIG. 2A shows a control waveform for a primary side switching device of a phase shift full-bridge converter.

FIG. 2B shows a control waveform for a secondary side switching device of a phase shift full-bridge converter.

Referring to FIG. 2A, in the primary side circuit unit of the phase shift full-bridge converter, the first switching device Q₁ and the second switching device Q₂ may be alternately turned on. In addition, the third switching device Q₃ and the fourth switching device Q₄ may be alternately turned on. In this case, a time at which the first switching device Q₁ is turned on and a time at which the fourth switching device Q₄ is turned on are phase-shifted. In addition, a time at which the second switching device Q₂ is turned on and a time at which the third switching device Q₃ is turned on are phase-shifted.

As such, the primary side switching device of the primary side circuit unit of the phase shift full-bridge converter may perform a zero voltage switching operation using a phase shift control signal.

Referring to FIG. 2B, the fifth switching device Q₅ may be turned on during a period in which the first switching device Q₁ or the fourth switching device Q₄ is turned on. In addition, the sixth switching device Q₆ may be turned on during a period in which the second switching device Q₂ or the third switching device Q₃ is turned on.

Meanwhile, the phase shift full-bridge converter may be controlled by various methods in addition to the method illustrated in FIGS. 2A and 2B.

Referring to FIG. 1, the standby power supply unit 200 may include a first flyback converter 210 converting the input power Vin into operating power Vccp having a preset magnitude to provide the operating power Vccp to the first controller 230 and a second flyback converter 220 converting the input power into power having a preset magnitude. The second flyback converter may provide power to the second controller 240 and a standby output terminal 290.

Meanwhile, the first flyback converter 210 may include a switching device Q7, a transformer N_{A} and N_{B1}, and a diode D_{A} as shown in FIG. 1. In addition, the second flyback converter 220 may include a switching device Q7, a transformer N_{A} and N_{B2}, and a diode D_{C} as shown in FIG. 1.

For example, when the main power supply unit 100 is not operated, the standby power supply unit 200 may convert the input power Vin into the operating power Vccp having the preset magnitude to provide the operating power Vccp to the first controller 230 and may convert the input power Vin into power having a preset magnitude to provide the power to the second controller 240 and the standby output terminal 290.

Meanwhile, the standby power supply unit 200 may include an auxiliary winding Nₐᵤₓ coupled to the transformer 101 and 102 of the main power supply unit 100 and may provide operating power Vₐᵤₓ applied to the auxiliary winding Nₐᵤₓ to the first controller 230 when the main power supply unit 100 is operated. Here, the first controller 230 may control an operation of the primary side circuit unit of the main power supply unit 100.

In addition, the standby power supply unit 200 may receive main power by the power transferring unit 300 to provide the main power to the second controller 240 and the standby output terminal 290. Here, the second controller 240 may control an operation of the secondary side circuit unit of the main power supply unit 100.

Meanwhile, the power transferring unit 300 may provide the main power to the standby power supply unit 200.

For example, the power transferring unit 300 may include a transfer diode Dm having an anode connected to the main output terminal 190 and a cathode connected to the standby output terminal 290. The transfer diode Dm may be turned on by the main power from the main power supply unit 100 and may provide standby power to the standby power supply unit 200.

In the case in which the first flyback converter 210 and the second flyback converter 220 of the standby power supply unit 200 supply power to the first controller 230, the second controller 240, and the standby output terminal 290, efficiency may be inevitably reduced due to intrinsic characteristics of the flyback converter (e.g., high voltage stress, hard switching, and snubber loss).

However, in the power supply apparatus according to an exemplary embodiment of the present disclosure, when the main power supply unit 100 is operated, power may be supplied to the first controller 230, the second controller 240, and the standby output terminal 290 by the main power supply unit 100. The main power supply unit 100 according to an exemplary embodiment of the present disclosure may be configured of the phase shift full-bridge converter, and thus, relatively high efficiency due to the zero voltage switching may be provided to thereby improve efficiency of the entire system.

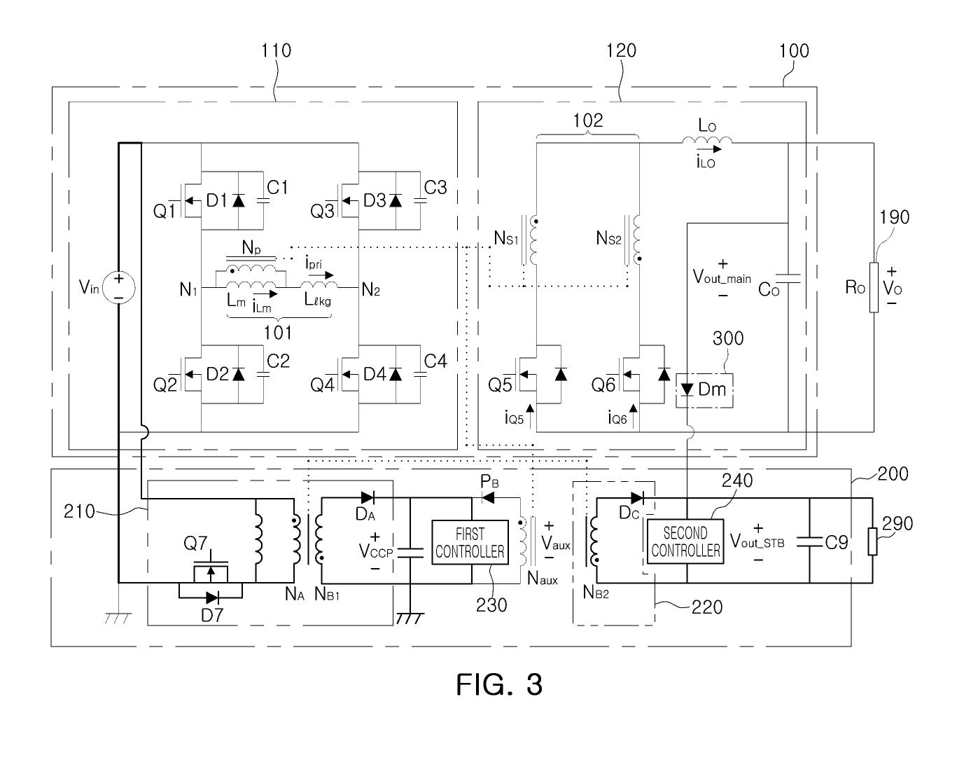

FIG. 3 is a diagram illustrating a power supply path to a first controller, a second controller, and a standby output terminal when a main power supply unit 100 is not operated.

Referring to FIG. 3, when the main power supply unit 100 is not operated, the standby power supply unit 200 may convert input power Vin into operating power Vccp having a preset magnitude using the first converter 210 and provide the operating power to the first controller 230.

In addition, when the main power supply unit 100 is not operated, the standby power supply unit 200 may convert the input power Vin into the power having the preset magnitude using the second converter 220 and provide the power to the second controller 240 and the standby output terminal 290.

In the case in which the first flyback converter 210 and the second flyback converter 220 of the standby power supply unit 200 supply power to the first controller 230, the second controller 240, and the standby output terminal 290, efficiency may be inevitably reduced due to intrinsic characteristics of the flyback converter (e.g., high voltage stress, hard switching, and snubber loss).

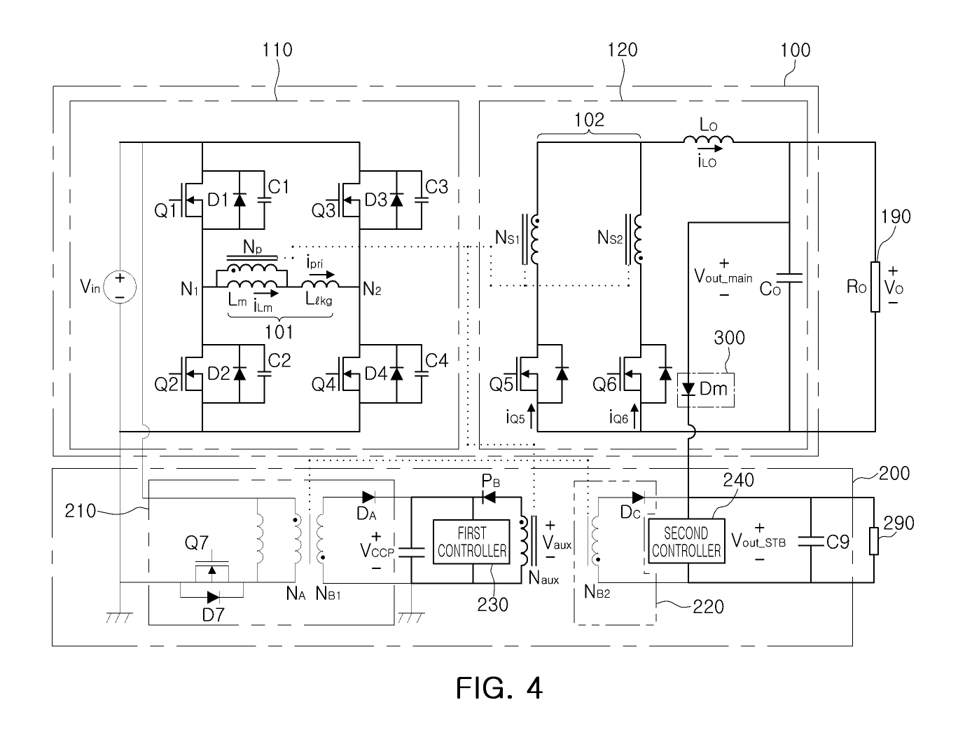

FIG. 4 is a diagram illustrating the power supply path to the first controller, the second controller, and the standby output terminal when the main power supply unit 100 is operated.

The standby power supply unit 200 may include an auxiliary winding Nₐᵤₓ coupled to the transformer 101 and 102 of the main power supply unit 100 and may provide operating power Vₐᵤₓ applied to the auxiliary winding to the first controller 230 when the main power supply unit 100 is operated.

In addition, the standby power supply unit 200 may receive main power from the power transferring unit 300 to provide the main power to the second controller 240 and the standby output terminal 290.

According to an exemplary embodiment of the present disclosure, in the case in which the main power supply unit 100 configured of the phase shift full-bridge converter having high efficiency is operated, since the main power supply unit 100 supplies the power to the first controller 230, the second controller 240, and the standby output terminal 290, efficiency of the entire system may be improved.

The first flyback converter 210 and the second flyback converter 220 may be operated in a bust mode when the main power supply unit 100 is operated. Alternatively, the first flyback converter 210 and the second flyback converter 220 may be stopped when the main power supply unit 100 is operated.

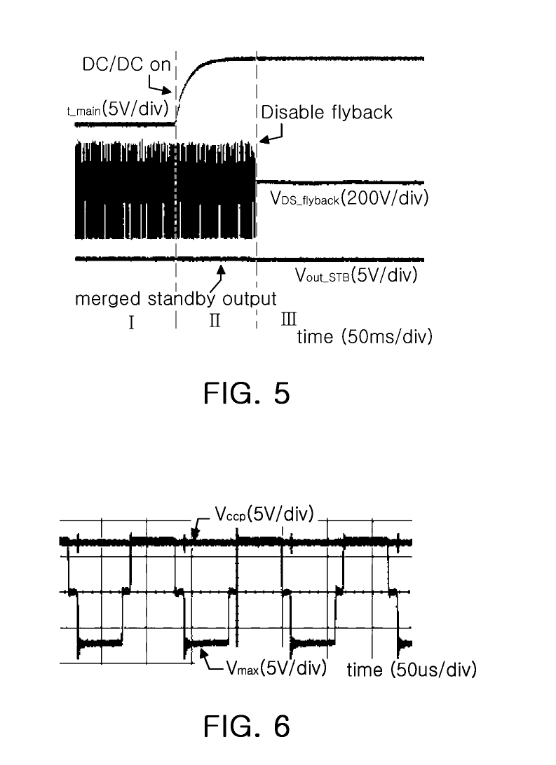

FIG. 5 is a waveform diagram illustrating an operation and standby power of a flyback converter of a standby power supply unit according to an operation of the main power supply unit.

Referring to FIGS. 1 and 5, a period I indicates a period in which the main power supply unit 100 is not operated, a period II indicates an initial period in which the main power supply unit 100 starts to operate, and a period III indicates a period in which the main power supply unit 100 is operated.

In the period I, since the main power supply unit 100 is not operated, the main power Vout_main is not output, the flyback converter of the standby power supply unit 200 is operated, and the standby power Vout_stb is applied by the flyback converter of the standby power supply unit 200.

In the period II, since the main power supply unit 100 starts to operate, the main power Vout_main begins to be output.

In the period III, since the main power supply unit 100 is operated, the main power Vout_main is output, the flyback converter of the standby power supply unit 200 is stopped, and the standby power Vout_stb is applied by the power transferring unit.

After the main power supply unit 100 fully starts to operate, since the operation of the flyback converter 200 of the standby power supply unit is stopped, loss of the flyback converter may be removed.

FIG. 6 is a diagram illustrating a waveform of a voltage Vccp applied to the first controller.

Referring to FIG. 6, it may be appreciated that a maximum value of the voltage Vₐᵤₓ proportional to the number of turns of the auxiliary winding is provided to the first controller.

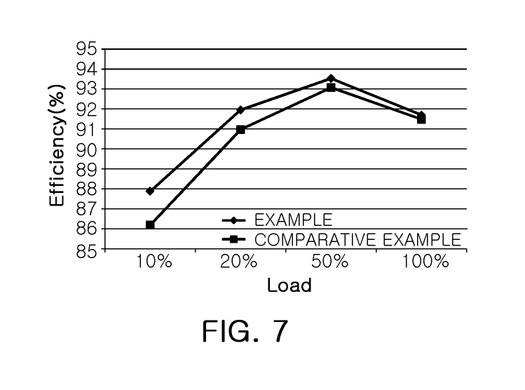

FIG. 7 is a diagram illustrating power supply efficiencies according to load conditions of a power supply apparatus for a server according to an exemplary embodiment of the present disclosure and a power supply apparatus for a server according to the related art.

It may be confirmed that the power supply apparatus for the server (Example) according to an exemplary embodiment of the present disclosure represents relatively high efficiency in the entire load region as compared to the power supply apparatus for the server (Comparative Example) according to the related art. In detail, it may be confirmed that the power supply apparatus according to an exemplary embodiment of the present disclosure has efficiency significantly increased in a light load region.

The power supply apparatus for the server, according to an exemplary embodiment of the present disclosure, may be configured by applying a relatively simple control scheme almost without changing power density in the power supply apparatus for the server according to the related art, such that efficiency may be significantly increased. Therefore, the proposed scheme may be relatively simple and effective.

According to exemplary embodiments of the present disclosure, the power supply apparatus having the improved power efficiency may be provided.

While exemplary embodiments have been shown and described above, it will be apparent to those skilled in the art that modifications and variations could be made without departing from the spirit and scope of the present disclosure as defined by the appended claims.

What is claimed is:

1. A power supply apparatus comprising:
a power supply unit including a transformer switching and transforming input power and converting the input power into output power having a magnitude to provide the output power to an output terminal;
a power transferring unit providing the output power; and
a standby power supply unit including an auxiliary winding coupled to the transformer, providing operating power to a first controller by the auxiliary winding and receiving the output power to provide the output power to a second controller and a standby output terminal when the power supply unit is operated.

2. The power supply apparatus of claim 1, wherein the standby power supply unit converts the input power into operating power having a preset magnitude to provide the operating power to the first controller and converts the input power into power having a preset magnitude to provide the power to the second controller and the standby output terminal, when the power supply unit is not operated.

3. The power supply apparatus of claim 1, wherein the power transferring unit comprises a transfer diode including an anode connected to the output terminal and a cathode connected to the standby output terminal, and
the transfer diode is turned on by the output power from the power supply unit and provides standby power to the standby power supply unit.

4. The power supply apparatus of claim 1, wherein the power supply unit comprises:
a primary side circuit unit including a primary side winding of the transformer and a plurality of primary side switching devices controlling a current flowing in the primary side winding of the transformer; and
a secondary side circuit unit including a plurality of secondary side windings magnetically coupled to the primary side winding of the transformer and a plurality of secondary side switching devices conducting currents from the secondary side windings.

5. The power supply apparatus of claim 4, wherein the primary side switching devices include a first switching device and a second switching device connected to each other in series and a third switching device and a fourth switching device connected to each other in series,
both terminals of the first switching device and the second switching device connected in series are connected to a power input terminal in parallel and both terminals of the third switching device and the fourth switching device connected in series are connected to the power input terminal in parallel, and
the primary side winding of the transformer is connected between a first node, a connection point between the first switching device and the second switching device, and a second node, a connection point between the third switching device and the fourth switching device.

6. The power supply apparatus of claim 5, wherein the secondary side winding includes a first secondary side winding and a second secondary side winding connected to each other in parallel, and
the secondary side switching devices include a fifth switching device allowing for or cutting a flow of current in the first secondary side winding and a sixth switching device allowing for or cutting a flow of current in the second secondary side winding.

7. The power supply apparatus of claim 2, wherein the standby power supply unit includes a first flyback converter converting the input power into the operating power having the preset magnitude to provide the operating power to the first controller and a second flyback converter converting the input power into the power having the preset magnitude.

8. The power supply apparatus of claim 7, wherein the first flyback converter and the second flyback converter are operated in a bust mode when the power supply unit is operated.

9. The power supply apparatus of claim 7, wherein the first flyback converter and the second flyback converter are stopped when the power supply unit is operated.

10. A power supply apparatus comprising:
a power supply unit including a transformer switching and transforming input power and converting the input power into output power having a preset magnitude to provide the output power to a output terminal;
a power transferring unit providing the output power; and
a standby power supply unit including a first controller receiving operating power by an auxiliary winding coupled to the transformer and a second controller receiving power by the power transferring unit, when the power supply unit is operated.
